(19) United States
(12) Patent Application Publication
(10) Pub. No.: US 2011/0018812 A1
(43) Pub. Date: Jan. 27, 2011

(54) Fast Typographical Error Correction for Touchscreen Keyboards

(75) Inventor: Randall B. Baird, Austin, TX (US)

Correspondence Address: Edell, Shapiro, & Finnan, LLC, 1901 Research Blvd, Suite 400, Rockville, MD, 20850, US

(73) Assignee: CISCO TECHNOLOGY, INC., San Jose, CA (US)

(21) Appl. No.: 12/506,564

(22) Filed: Jul. 21, 2009

(51) Int. Cl. G06F 3/041

(52) U.S. Cl. 345/173

(57) ABSTRACT

Techniques are provided for receiving an input from a touchscreen keyboard of a touchscreen display device having a display area, where the touchscreen keyboard is displayed in a first part of a display area and the input represents a selected key on the touchscreen keyboard. A character corresponding to the selected key is displayed in a text box that is displayed in a second part of the display area. A set of adjacent keys are determined that are adjacent to the selected key on the touchscreen keyboard, and the selected key and the set of adjacent keys are displayed in a third part of the display area. A correction touchscreen input is received from the third part of the display area for a key selected from among the set of adjacent keys, and a character displayed in the text box is replaced with a character corresponding to the correction touchscreen input.

### TECHNICAL FIELD

The present disclosure relates to touchscreen keyboards and more particularly to correcting errors when a user inadvertently touches an area of a touchscreen causing an undesired input.

### BACKGROUND

Modern handheld devices such as cellular telephones, personal data assistants, gaming devices, and the like employ touchscreens with ever increasing frequency. Many of these devices come equipped with a touchscreen virtual keyboard for typing text and symbols used for text messaging, World Wide Web surfing, and creating documents, etc. The devices are constrained in size according to what individuals are willing to carry. This also places a limit on the size of the touchscreen keyboard and related graphical user interface functions on the device. In many instances the keys on the touchscreen keyboard are smaller than the user's fingers, leading the user to touch an unintended area of the touchscreen keyboard while typing. Touching an incorrect area of the touchscreen keyboard causes typographical errors commonly known as “fat-finger” errors.

### BRIEF DESCRIPTION OF THE DRAWINGS

FIG. 1 is an example of a block diagram of a device configured to implement input error correction process logic.

FIG. 2 is an example of a touchscreen display for a handheld device with a portion of the touchscreen display area dedicated to input error correction.

FIG. 3 is a flow chart generally depicting the input error correction process logic.

FIGS. 4-10 are flow charts generally depicting an example implementation of the input error correction process logic.

FIGS. 11-31 depict an example sequence of steps a user may take to correct input errors using the device from FIG. 2.

FIGS. 32-37 depict alternative displays for the input error correction area of the touchscreen display.

### DESCRIPTION OF EXAMPLE EMBODIMENTS

### Overview

Techniques are provided for receiving an input from a touchscreen keyboard of a touchscreen display device having a display area, where the touchscreen keyboard is displayed in a first part of a display area and the input represents a selected key on the touchscreen keyboard. A character corresponding to the selected key is added to a text box that is displayed in a second part of the display area. A set of adjacent keys are determined that are adjacent to the selected key on the touchscreen keyboard, and the selected key and the set of adjacent keys are displayed in a third part of the display area. A correction touchscreen input is received from the third part of the display area for a key selected from among the set of adjacent keys, and a character displayed in the text box is replaced with a character corresponding to the correction touchscreen input.

### Example Embodiments

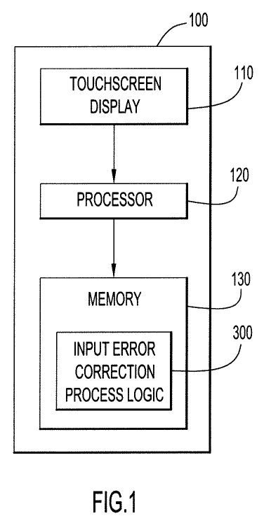

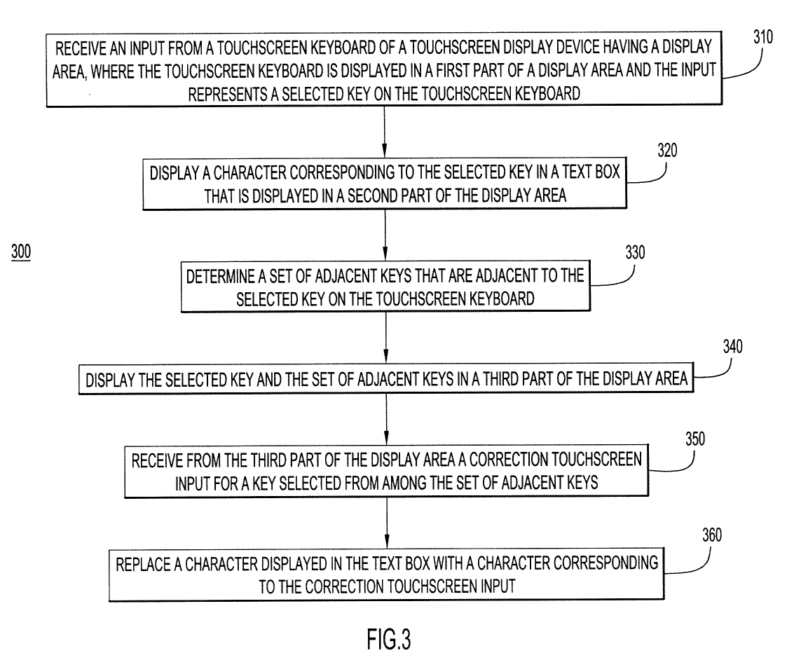

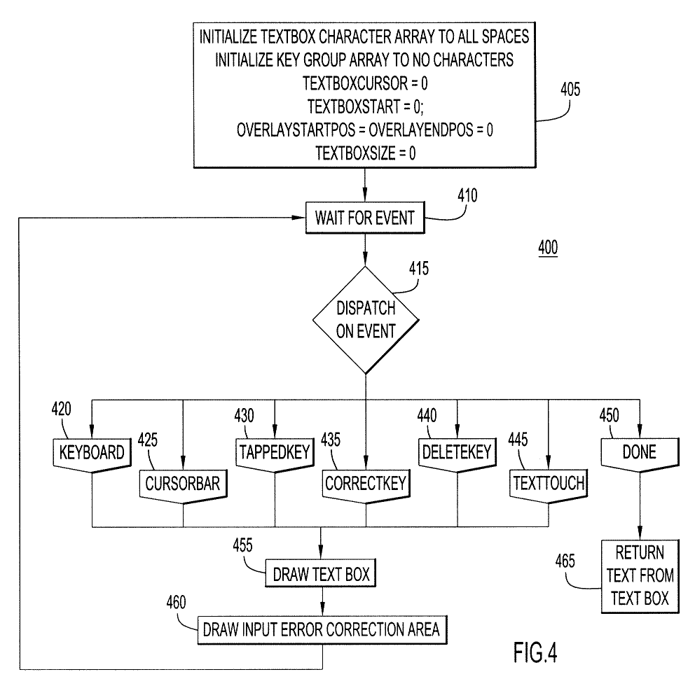

Referring first to FIG. 1, an example of a block diagram is shown of a device 100 that is configured to implement input error correction techniques described herein. The device 100 comprises a touchscreen display 110, a data processing device 120, e.g., a microprocessor, microcontroller, etc., and a memory 130 or other data storage block that stores data used for the techniques described herein. The memory 130 may be separate or part of the processor 120. Instructions for performing the input error correction process logic 300 may be stored in the memory 130 for execution by the processor 120. The process logic 300 allows a user to quickly and easily correct typographical errors while typing on the touchscreen display 110 of device 100. The process logic 300 is described in conjunction with FIG. 3, an example implementation is shown in a series of flow charts in FIGS. 4-10, and user-based examples are described in conjunction with FIGS. 11-31.

The functions of the processor 120 may be implemented by logic encoded in one or more tangible media (e.g., embedded logic such as an application specific integrated circuit (ASIC), digital signal processor (DSP) instructions, software that is executed by a processor, etc.), wherein the memory 130 stores data used for the computations or functions described herein (and/or stores software or processor instructions that are executed to carry out the computations or functions described herein). Thus, the process logic 300 may be implemented with fixed logic or programmable logic (e.g., software/computer instructions executed by a processor or field programmable gate array (FPGA)).

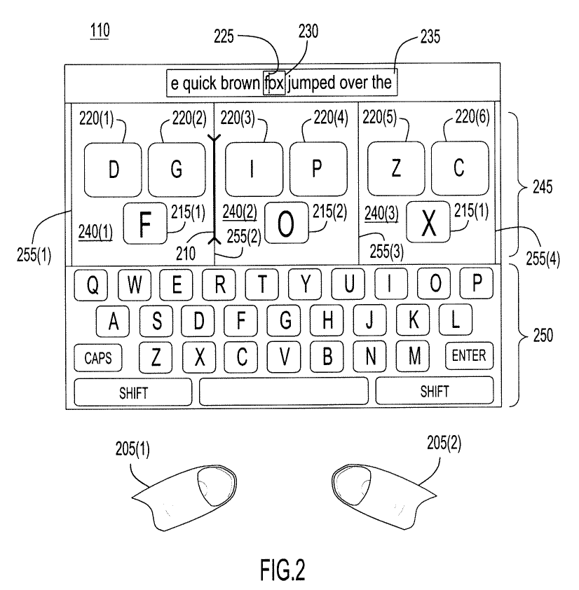

Turning to FIG. 2, an example touchscreen display, e.g., touchscreen display 110 is shown for device 100 with a portion of the touchscreen display area dedicated to “fat-finger” or input error correction, i.e., an input error correction display area. The touchscreen display 110 comprises a touchscreen keyboard 250, an input error correction area 245, and a text box 235. As used herein, the term “text box” generally refers to any area on the touchscreen display where a user may enter text, characters, or symbols. For ease of explanation, a common set of terms is used in describing the process logic 300 in conjunction with touchscreen 110. First, at 205(1) and 205(2) a set of user fingers, thumbs, or digits is shown. The digits 205 are shown moved about the touchscreen 110 in the various figures referred to herein to mimic a user input to the device 100 via the touchscreen 110. In the following examples, the user selects or “taps” text characters on the keyboard 250. The process logic 300 waits for a user input before any stage or operation of the process logic 300 commences, and therefore, the process logic 300 is event driven.

Next, an enlarged cursor is shown at 210. The enlarged cursor 210 corresponds to a regular text box cursor 225 within the text box 235. The cursors 210 and 225 behave like cursors in a normal word processing application, and act as character insertion points or character deletion points. A distinguishing indicator may be provided to highlight or window a set of contiguous characters within the text box. As shown, a text box overlay or window 230 surrounds a portion of the text and text box cursor 225 within the text box 235. The overlay may be sized to accommodate N characters. A set of N selected keys corresponding to text within the overlay 230 is also displayed within the error correction area 245 of the touchscreen 110 such that there is one-to-one correspondence between text and cursor in the overlay 230, and the text and cursor displayed in the error correction area 245. In the example shown in FIG. 2, N is equal to three and “f|ox” is displayed in the overlay 230 and in the error correction area 245. As characters are added or deleted, i.e., as consecutive inputs are received, the window/overlay 230 maintains a position relative to the cursor and the set of N selected keys corresponding to the characters displayed in the window are updated in the error correction area 245 accordingly.

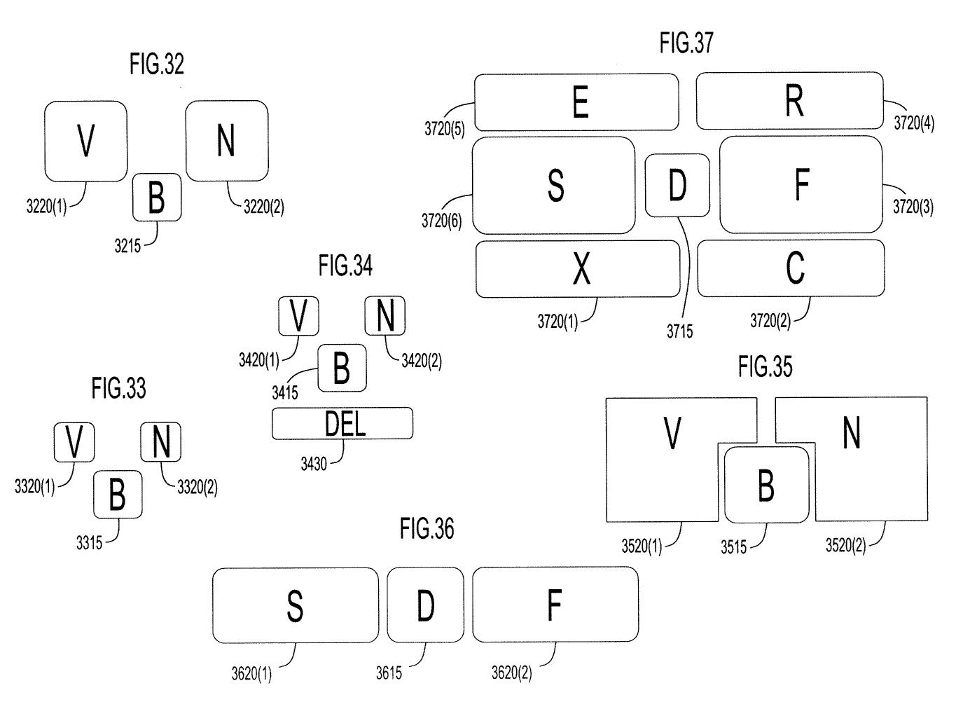

Within the error correction area 245 are three key groups 240(1)-240(3) and four enlarged cursor bars 255(1)-255(4) dispersed outside of and between the key groups 240(1)-240(3). The enlarged cursor bars 255(1)-255(4) represent positions within the error correction area 245 where a large cursor may be positioned or displayed. Each key group consists of a corresponding user-selected or tapped key and associated error correction keys. For example, key group 240(1) consists of tapped key “F” at 215(1) and error correction keys “D” and “G” at 220(1) and 220(2), respectively; key group 240(2) consists of tapped key “O” at 215(2) and error correction keys “I” and “P” at 220(3) and 220(4), respectively; and key group 240(3) consists of tapped key “X” at 215(3) and error correction keys “Z” and “C” at 220(5) and 220(6), respectively. Although only three key groups are displayed, it should be understood that any number up to N key groups may be displayed within the limits of the size of the error correction area 245 and the number of displayed key groups N may depend upon the design constraints of the device 100. As described above, the overlay 230 could be sized to accommodate the N selected or tapped characters. In this depiction, the error correction keys are keys that are horizontally adjacent to the tapped key on the keyboard 250 of the touchscreen 110, i.e., error correction keys “D” and “G” of key group 240(1) are horizontally adjacent to the key “F” on the keyboard 250. Although only two adjacent keys are shown, any of the keys adjacent to the selected key may be displayed in a key group and form a set of adjacent keys shown in the error correction area 245. The selected or tapped key “F” of key group 240(1) represents a key that was typed in by the user. This example was chosen because most “fat-finger” errors occur due to an inadvertent touching of a horizontally adjacent key as opposed to a vertically adjacent key. To aid the user, the set of adjacent keys are displayed enlarged relative to the size of the keys displayed in the touchscreen keyboard 250, thereby increasing the likelihood of the user being able to swiftly and accurately correct any error. Other example key group embodiments will be discussed in conjunction with FIGS. 32-37. In another embodiment, the tapped keys 215 and error correction keys 220 may be case-sensitive to more accurately reflect the correspondence between the text in the text box 235 and the error correction area 245.

Turning now to FIG. 3, a flow chart generally depicting the input error correction process logic 300 is shown. At 310, an input is received from a touchscreen keyboard of a touchscreen display device having a display area, where the touchscreen keyboard is displayed in a first part of a display area and the input represents a selected key on the touchscreen keyboard. In one example, the user would tap a key on the keyboard 250. At 320, a character corresponding to the selected key is displayed in a text box that is displayed in a second part of the display area, e.g., text box 235. In one example, the character will be added to the text box at a position corresponding to the current cursor position. At 330, a set of adjacent keys are determined that are adjacent to the selected key on the touchscreen keyboard. In one example, the keys could be the horizontally adjacent keys as described above. Next, at 340, the selected key and the set of adjacent keys are displayed in a third part of the display area, e.g., the input error correction area 245. At 350, a correction touchscreen input for a key selected from among the set of adjacent keys is received from the third part of the display area. In one example, the user has tapped an error correction key, e.g., one of error correction keys 220(1)-220(6). Lastly, at 360, a character displayed in the text box is replaced with a character corresponding to the correction touchscreen input and the error correction key group is updated to reflect the correction, thereby correcting a typographical error.

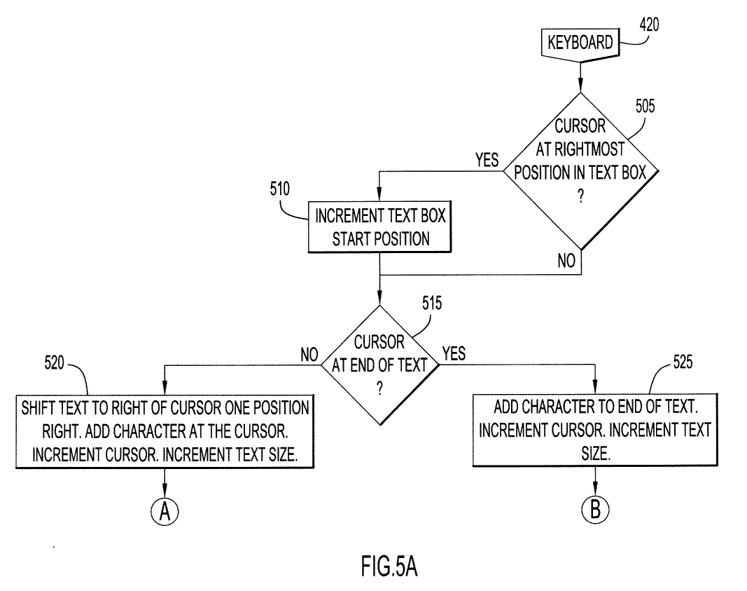

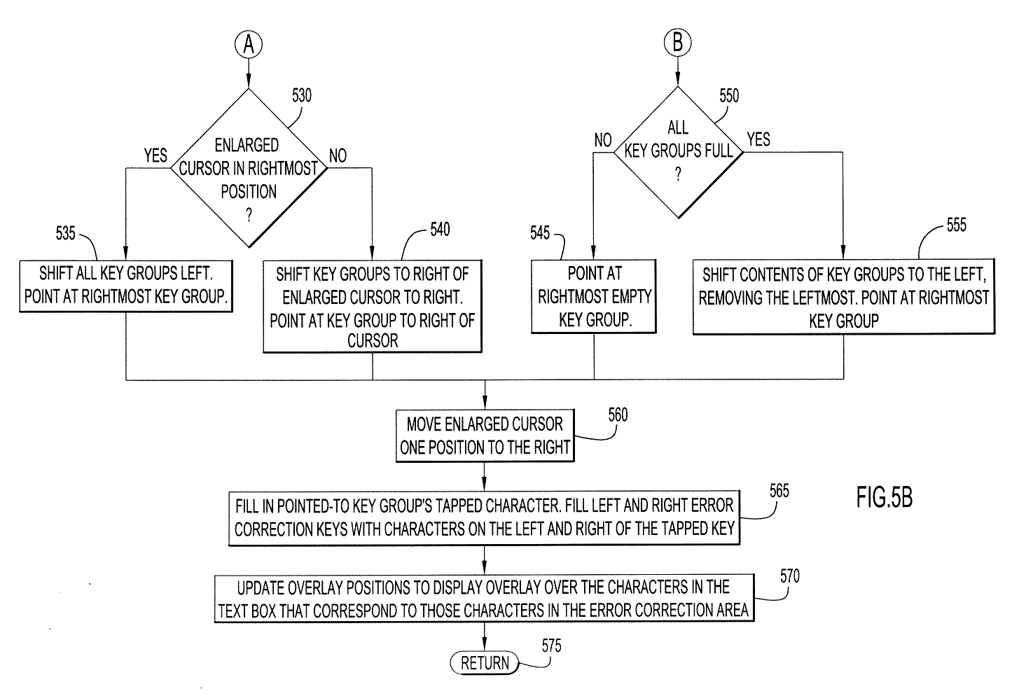

Referring to FIG. 4, a flow chart of an example implementation of the input error correction process logic 300 is shown at 400. A display initialization and associated initialization variable functions are shown at 405 and may comprise other variables or application specific elements. In this example, the text box variables are initialized for text box 235. Variables for the input error correction area may also be initialized, and due to a correspondence between text in the overlay 230 and the set of N selected keys in the error correction area 245, the input correction area variables may be based on the text box variables. After initialization, the process logic waits at 410 for an event, e.g., a user input as described above. Upon an event occurrence, one or more sub-processes are dispatched at 415. In one example, the sub-processes include KEYBOARD process 420, CURSORBAR process 425, TAPPEDKEY process 430, CORRECTKEY process 435, DELETEKEY process 440, TEXTTOUCH process 445, and DONE 450. These sub-processes, each corresponding to a particular type of input event, i.e., based upon where the user taps the touchscreen, and are described in FIGS. 5-10.

The KEYBOARD process 420 is shown in FIGS. 5A and 5B. This process responds to a key tapped on the touchscreen keyboard 250. It controls the addition of characters to the text box 235 and affects the key groups 240 displayed in the error correction area 245 as a user is typing. As shown in FIG. 5A, flow chart steps 505-525, when executed, update the text box cursor 225 position, add a character to the text box 235, and, in the case where more characters have been entered than can be displayed simultaneously in the text box, shift text in the text box 235. The process continues from FIG. 5A to FIG. 5B as shown at A and B. Referring to FIG. 5B, flow chart steps 530-560, when executed, update the corresponding enlarged cursor 210 position and shift text in the key groups 240(1)-240(3). At 565, the newly tapped character and corresponding error correction keys are inserted into the key group in the error correction area 245 corresponding to the enlarged cursor position. At 570, the text box overlay 230 position is updated. At 575, the KEYBOARD process 420 returns to wait for the next event at 410.

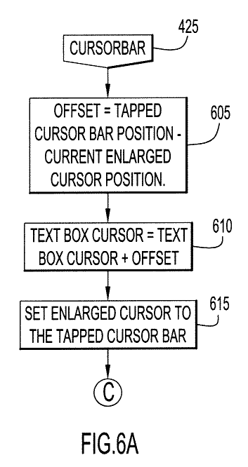

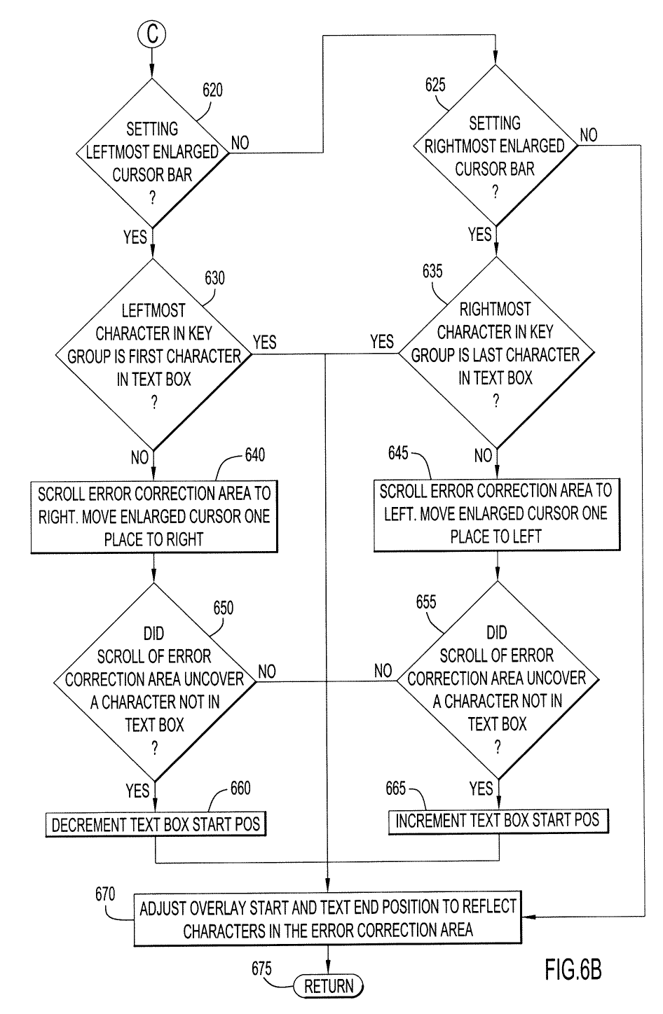

Turning to FIGS. 6A and 6B, a flow chart for the CURSORBAR process 425 is shown. In general, the CURSORBAR process 425 operates by responding to an input event from the error correction area 245 representing tapping one of the enlarged cursor bars 255(2) or 255(3) between selected keys, or to the left (enlarged cursor bar 255(1)) and right (enlarged cursor bar 255(4)) of the rightmost and leftmost key groups, respectively. The enlarged cursor 210 is moved to an area within in the error correction area 245 corresponding to the input, and the text box cursor 225 is moved to an area within the text box corresponding to the position of the enlarged cursor 210. If the leftmost area 255(1) is tapped and the leftmost key group 240(1) does not represent the first character in the text box 235, the contents of the key groups 240(1)-240(3) are scrolled to the right, the enlarged cursor is placed at area 255(2), and the window 230 and cursor 225 in the text box 235 are correspondingly updated. If the rightmost area 255(4) is tapped and the rightmost key group 240(3) does not represent the last character in the text box 235, the contents of the key groups 240(1)-240(3) are scrolled to the left, the enlarged cursor is placed at area 255(3), and the window 230 and cursor 225 in the text box 235 are correspondingly updated. By scrolling the key groups thusly, the user can scroll through all text in the text box one character at a time by repeatedly tapping the leftmost area 255(1) or rightmost area 255(4). Thus, the CURSORBAR process 425 is executed when a user taps one of the enlarged cursor bars 255(1)-255(4) in order to reposition the enlarged cursor 210. At 605, an offset is computed in order to reposition the text box cursor 225. At 610, the text box cursor 225 position is updated. At 615, the enlarged cursor 210 is moved to the tapped enlarged cursor bar. The process continues from FIG. 6A to FIG. 6B as shown at C. Referring to FIG. 6B, flow chart steps 620-645 detect when the enlarged cursor 210 is moved to either end of the error correction area 245 and scrolls the key groups in the error correction area 245. Steps 650-665 similarly scroll the visible text in the text box 235 if there is more text than can be displayed simultaneously in the text box 235 and any of the key groups 240(1)-240(3) now visible in the error correction area 245 correspond to a character now currently visible in the text box 235. At 670, the overlay 230 is adjusted to match the text in the error correction area 245. At 675, the CURSORBAR process 425 returns to wait for the next event at 410.

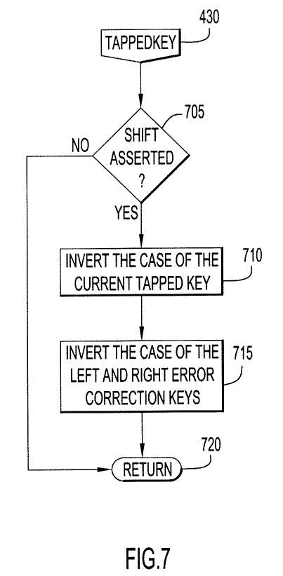

Turning to FIG. 7, a flow chart for the TAPPEDKEY process 430 is shown. The TAPPEDKEY process 430 is executed when a user taps one of the tapped keys 215(1)-215(3). The TAPPEDKEY process 430 inverts or changes the case for characters in one of the key groups 240(1)-240(3) corresponding to the tapped key. At 705, it is determined whether a “shift asserted” status has been detected. In one example, shift is asserted by tapping a “shift” key on the touchscreen keyboard 250, then tapping the key on the keyboard 250 for which the shift was intended. Note that the operation of a shift assertion on a touchscreen is somewhat different than the similar operation on a mechanical keyboard, since the size of the key representations on the screen are sufficiently small that in may be impossible to maintain contact with the shift key and tap the key for which the shift is intended. Steps 710 and 715 are executed if shift is asserted, causing the case of the current tapped key and the corresponding error correction keys to be inverted. At 720, the TAPPEDKEY process 430 returns to wait for the next event at 410.

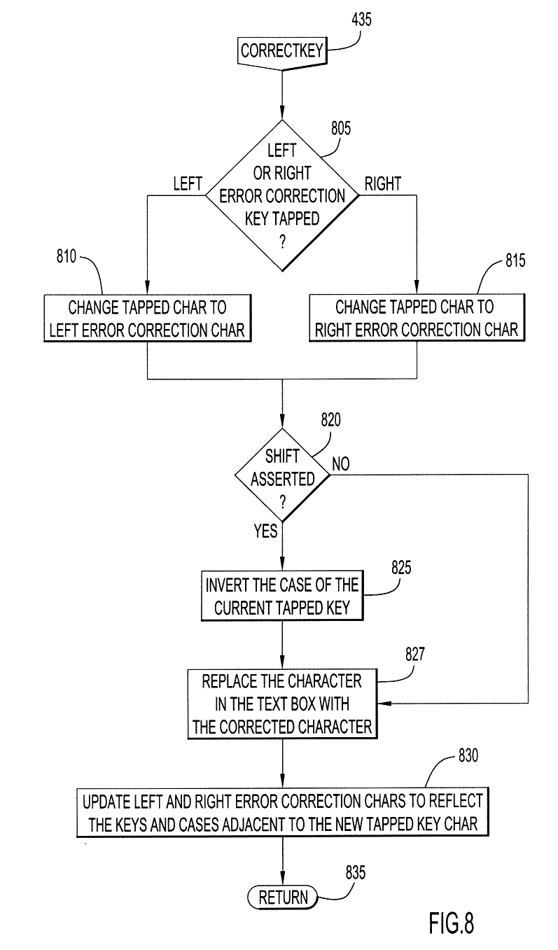

Referring to FIG. 8, a flow chart for the CORRECTKEY process 435 is shown. The CORRECTKEY process 435 is executed when a user taps one of the error correction keys 220(1)-220(6) thereby providing an error correction input. The CORRECTKEY process 435 in this example assumes only two error correction keys (left and right) are displayed for any given key group. At 805-815, the left or right error correction key has been tapped and the appropriate text in the text box 235 is corrected. At 820, the shift assertion status is determined, in a manner similar to step 705 of the TAPPEDKEY process 430. At 825, the case of the current tapped key and the corresponding error correction keys are inverted, if the shift is asserted. At 827, the character in the text box 235 is replaced with the corrected character. At 830, the characters displayed in the key group corresponding to the corrected character are updated to reflect the error correction input. At 835, the CORRECTKEY process 435 returns to wait for the next event at 410.

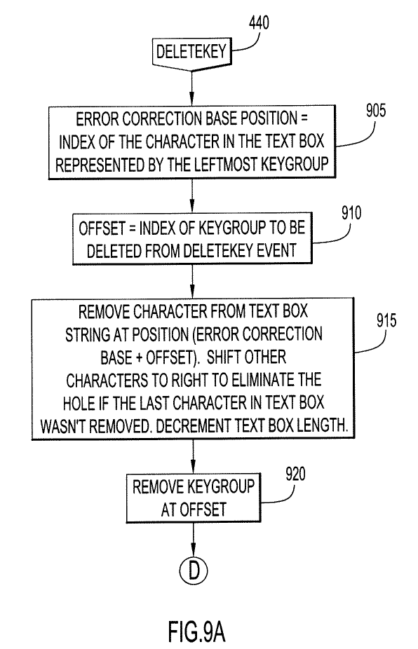

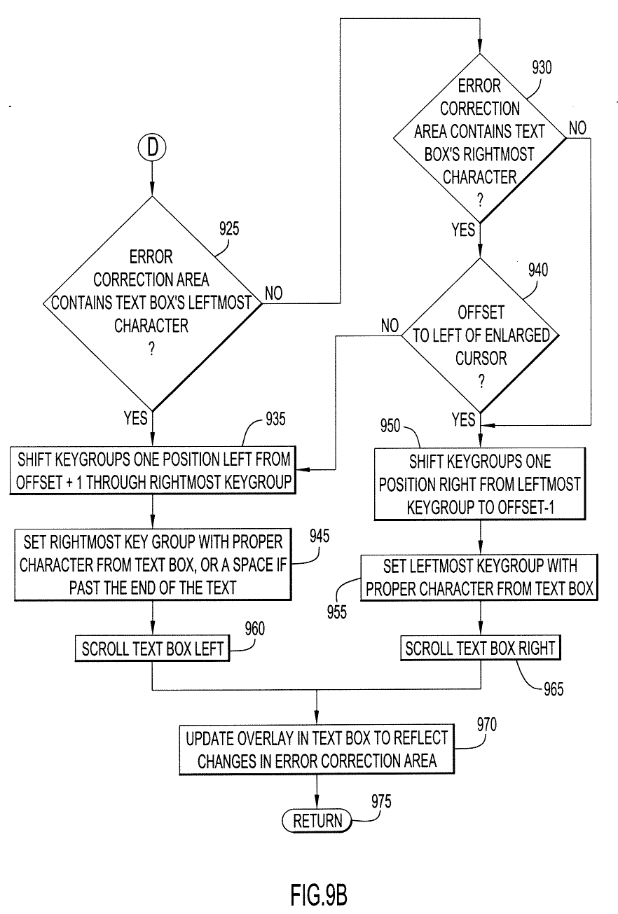

Turning now to FIGS. 9A and 9B, a flow chart for the DELETEKEY process 440 is shown. The DELETEKEY process 440 is executed when a user taps the “delete” button in one of the key groups in the error correction area 245, an example of which is shown in FIG. 34. In other embodiments, the “delete” button may be represented by an icon and may be positioned differently within the group, to minimize the chances of it being accidentally tapped. Flow chart steps 905-920, when executed, delete a character from the text box 235 and the corresponding key group in the error correction area 245. The process continues from FIG. 9A to FIG. 9B as shown at D. Referring to FIG. 9B, steps 925-955 justify and/or shift the key groups. Steps 960 and 965 scroll the text in the text box 235 either to the left or to the right to reflect the scrolling that occurred in the key groups 240. At 970, the overlay 230 is adjusted to match the text in the error correction area 245. At 975, the DELETEKEY process 440 returns to wait for the next event at 410.

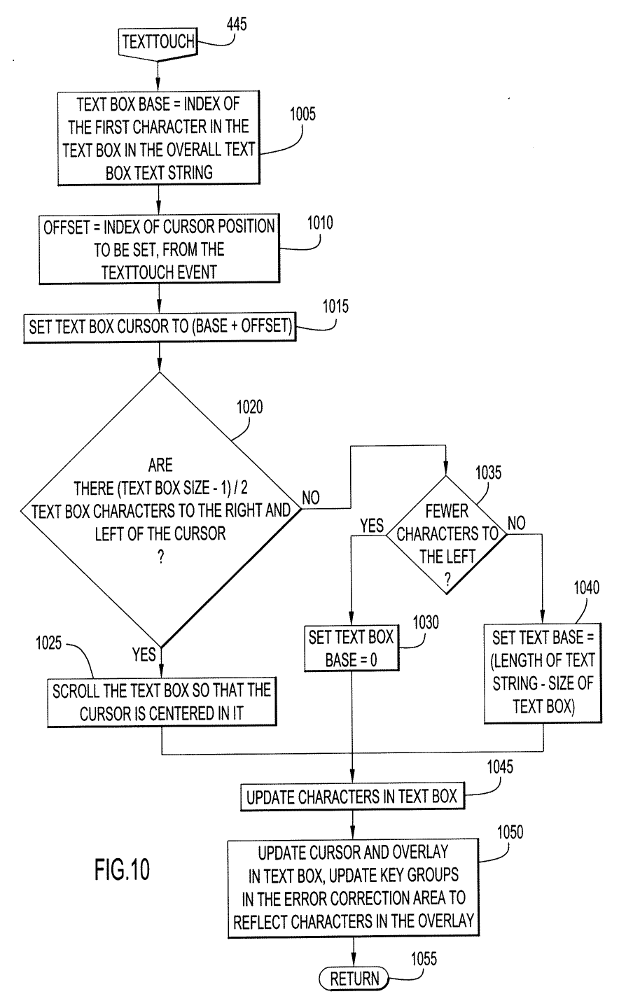

Referring to FIG. 10, a flow chart for the TEXTTOUCH process 445 is shown. In general, a touchscreen input in the text box 235 to set an approximate position of a cursor is received, where the window or overlay 230 maintains a position relative to the cursor. The set of N selected keys corresponding to the characters within the window are displayed in the error correction area 245 and the corresponding enlarged cursor 210 is displayed in the same relative position among the set of N selected keys as the cursor is displayed among the characters in the window 230. The TEXTTOUCH process 445 is executed when a user taps an area of the text box 235 in order to set an approximate position of the text box cursor 225. This process is provided because many more characters can be displayed in the text box 235 than in the error correction area 245. In this example, the text box cursor and the surrounding text are scrolled to the approximate center of the text box 235 when the text box 235 is fairly full and the cursor is repositioned without scrolling when the text box 235 is not so full. Steps 1005-1015 compute a base and offset for determining whether to scroll the text in the text box 235 or reposition the text box cursor 225 without scrolling. Steps 1020-1040 scroll the text in the text box 235 and reposition the text box cursor 225. At 1045, the characters in the text box 235 are updated. At 1050, the overlay 230 and text box cursor 225 are adjusted to match the outcome of steps 1020-1040. The set of N selected characters and the enlarged cursor 210 corresponding to the characters and text box cursor 225 in the overlay 230 are displayed in the error correction area 245. At 1055, the TEXTTOUCH process 445 returns to wait for the next event at 410.

Referring back to FIG. 4, after one or more sub-processes have been executed, the display or portions thereof may need to be refreshed with responses to the user inputs. At 455, the text window is drawn. At 460, the error correction area is drawn. Refreshing the display may include methods that page swap in memory, directly refresh the display memory, or use other techniques known to those skilled in the art. When the user is finished typing, an “enter” key or other terminating key is tapped. At this point, DONE 450 is called and the application returns the text from the text box at 465. This indicates to the application to process the text in the text box according to the specifics of the particular higher level application.

In other embodiments, additional text editing features may be present, including, but not limited to, use of the touch screen keyboard 250 backspace and/or delete keys, methods for clearing, cutting, copying, pasting, and duplicating text into the text box, and various word-completion technologies. Implementation of these features may result in changes to the key groups and cursors displayed in the error correction area 245.

Turning now to FIG. 11, an example is described for a user correcting “fat-finger” errors using the techniques described herein. In FIG. 11, a touchscreen, e.g., the touch screen 110, is shown in an initialized or power up state for an application that allows text entry, e.g., a web browsing application. In FIG. 12, a user starts typing. In this example the user is looking for a news story and wishes to browse the Cable News Network website, cnn.com. As shown in FIG. 12 the user types the “c” character on the touchscreen keyboard 250 using digit 205(1). In FIG. 13, the user has released the “c” key. In this example, the KEYBOARD process 420 would be called or executed. The letter “c” is placed in the text box 235 and a first key group 240(1) is displayed. The first key group consists of the “c” tapped key 215(1) and the horizontally adjacent “x” and “v” error correction keys 220(1) and 220(2), i.e., horizontally adjacent on the touchscreen keyboard 250. The enlarged cursor 210 and the text box cursor 225 are both shifted or advanced left to the next position.

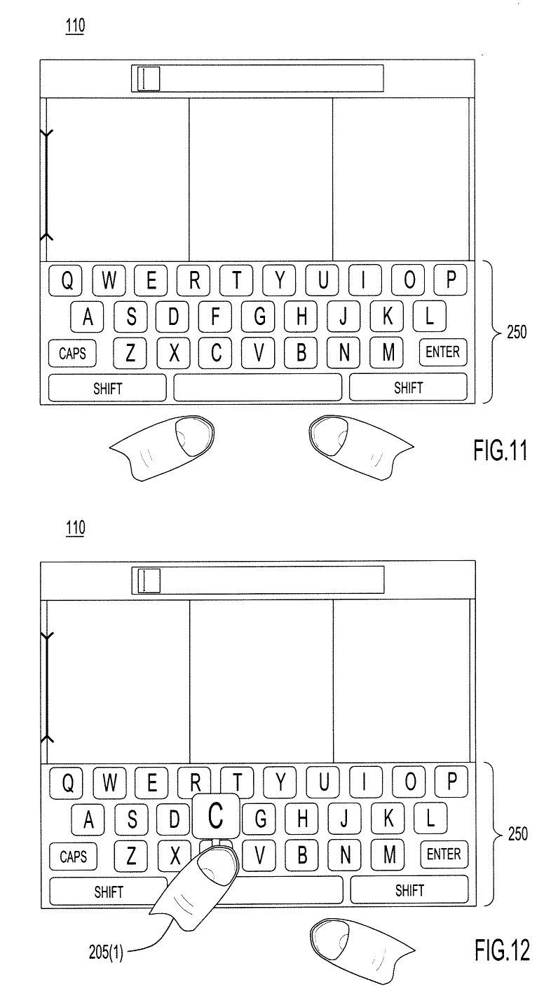

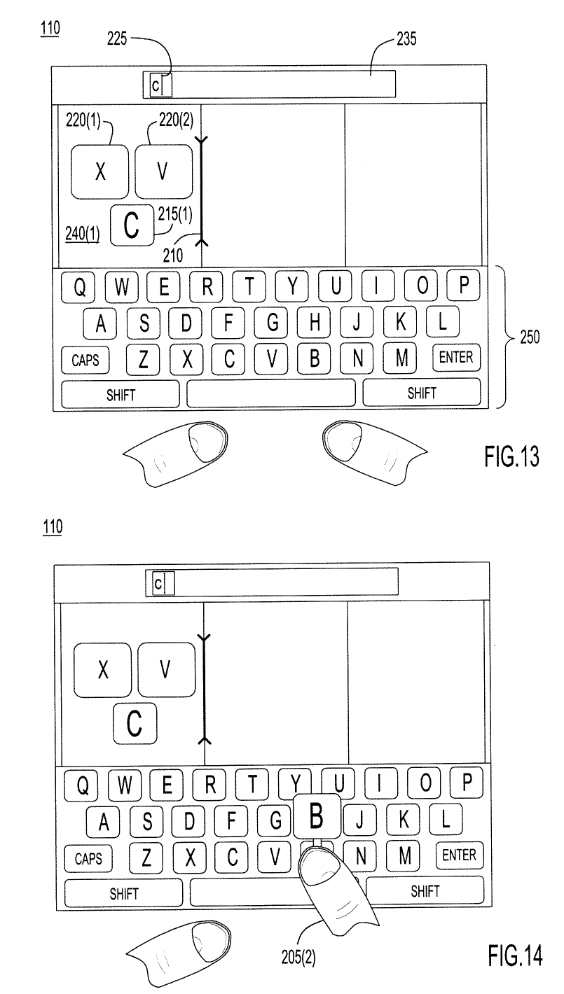

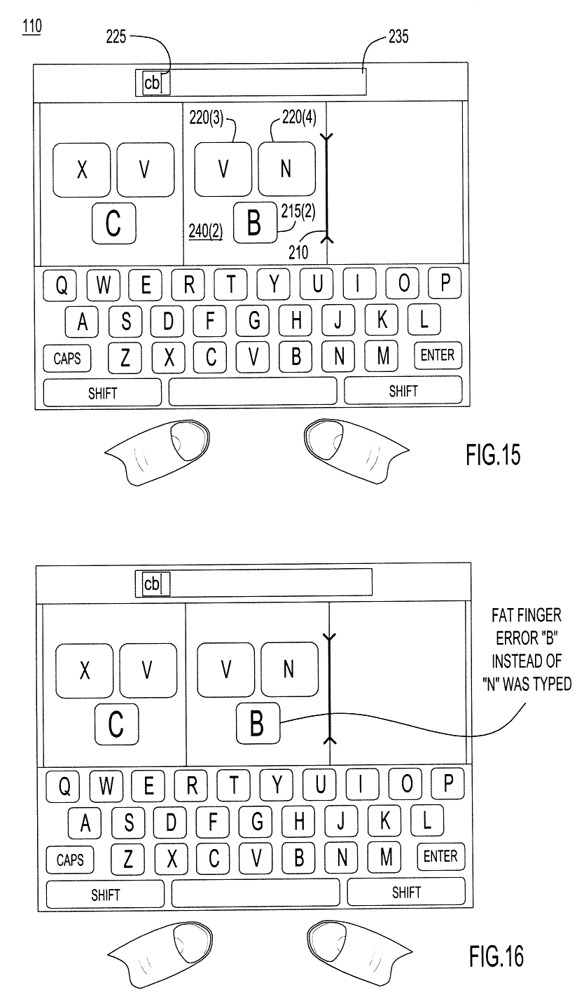

Referring to FIG. 14, the user next attempts to type the first “n” for cnn.com using digit 205(2). Instead, the user has made an input error and types a “b” instead. The corresponding sub-processes are then called and the display is updated as shown in FIG. 15. The letter “b” is placed in the text box 235 and a second key group 240(2) is displayed. The second key group consists of the “b” tapped key 215(2) and the horizontally adjacent “v” and “n” error correction keys 220(3) and 220(4). The enlarged cursor 210 and the text box cursor 225 are both shifted or advanced left to the next position. In FIG. 16, the user realizes an input error was made. In FIG. 17 the user corrects the error by tapping the “n” error correction key 220(4) in the second key group 240(2) using digit 205(2). In this case, since the user has tapped an error correction key, the CORRECTKEY process 435 is called. The corrected text is shown in FIG. 18. Both the text in the text box 235 and the characters in the second key group 240(2) have been corrected and/or updated.

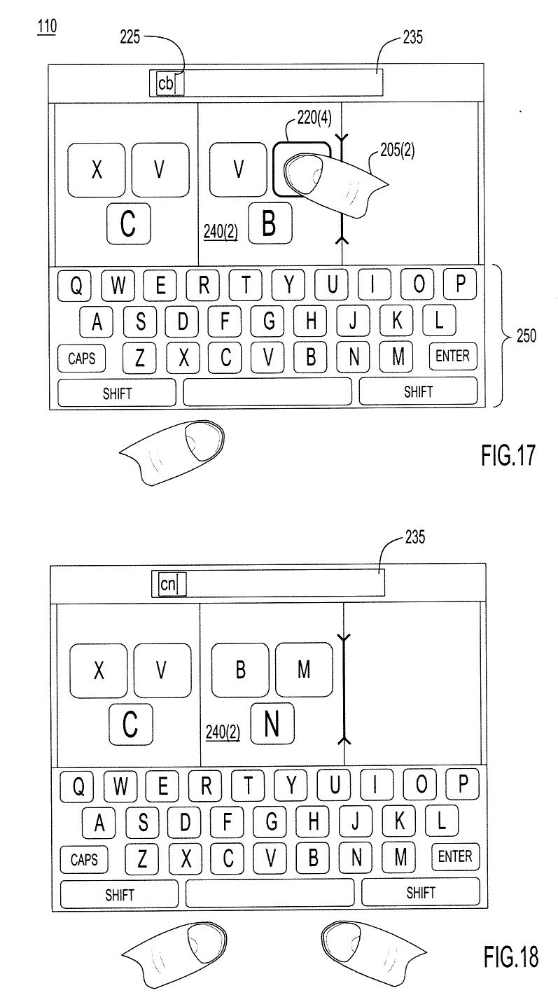

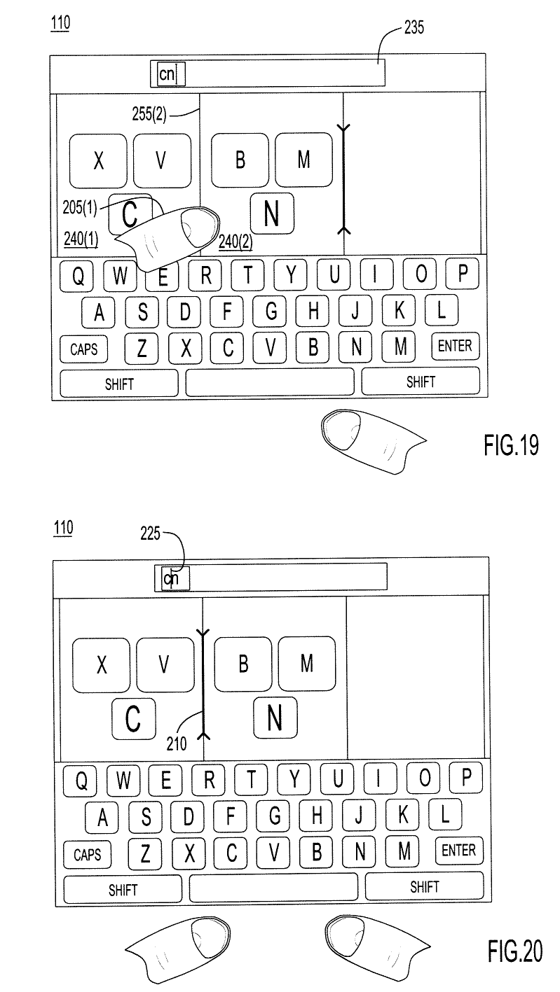

Referring now to FIG. 19, the user has realized that the news story is out of Canada and wishes to get the news story from the canada.com/news website. In this case, the user wishes to insert an “a” character between the “c” and “n” characters in the text box 235. The user taps the enlarged cursor bar 255(2) between the first and second key groups 240(1) and 240(2) using digit 205(1), as shown. FIG. 20 shows that the enlarged cursor 210 and the text box cursor 225 have moved between the “c” and “n” in response to the user input. In this instance, the CURSORBAR process 425 has been called. In FIG. 21, the user correctly types the “a” character using digit 205(1). The corresponding sub-processes are then called and the display is updated as shown in FIG. 22.

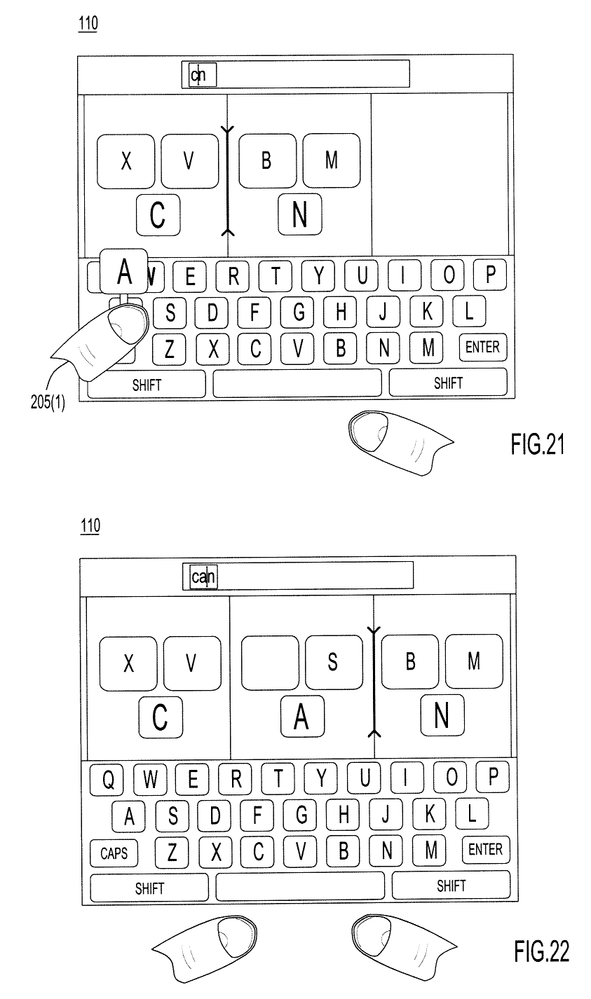

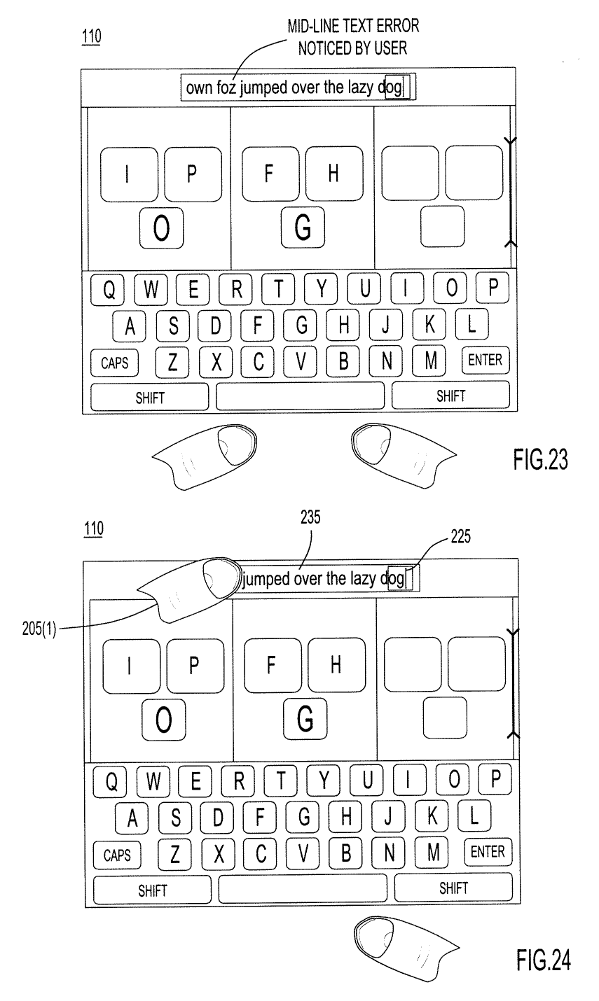

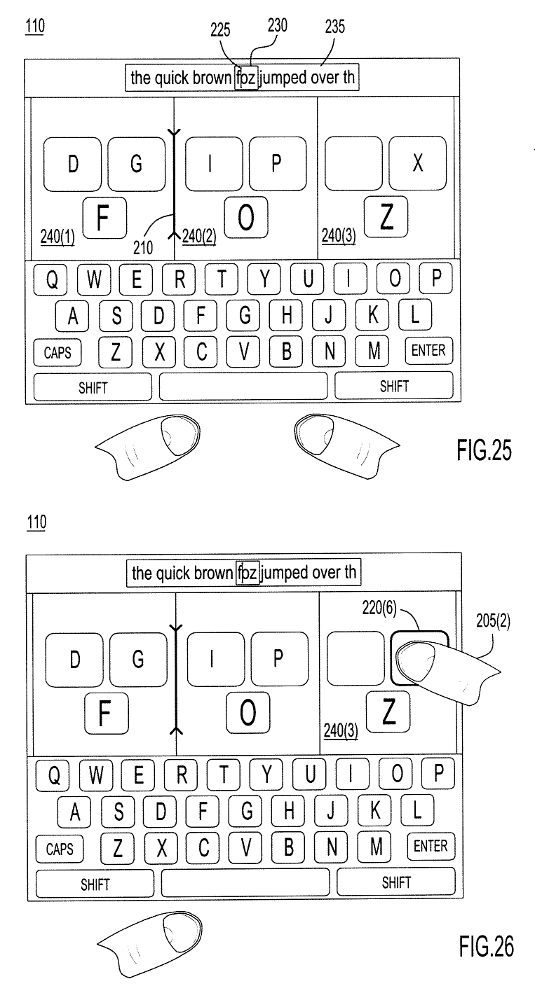

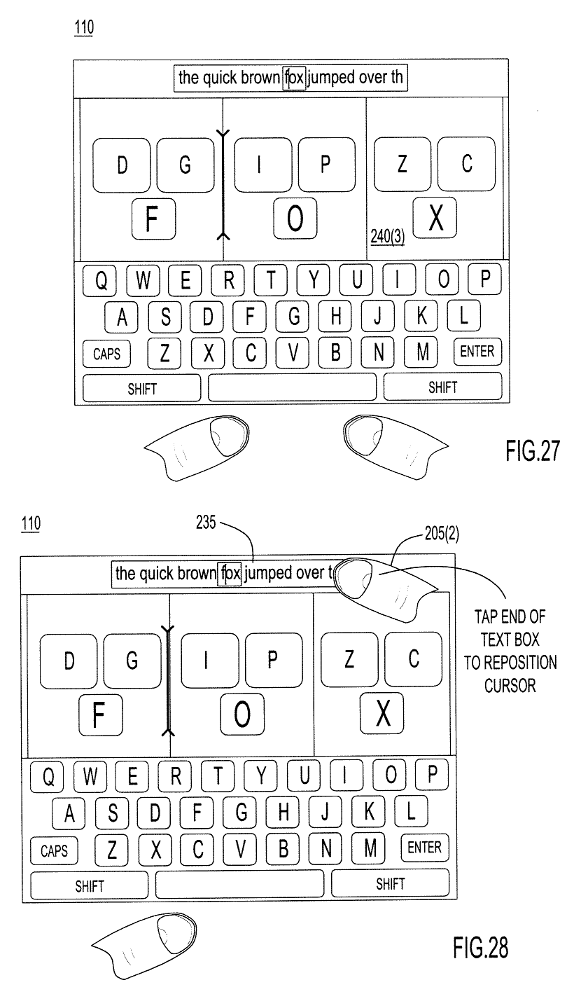

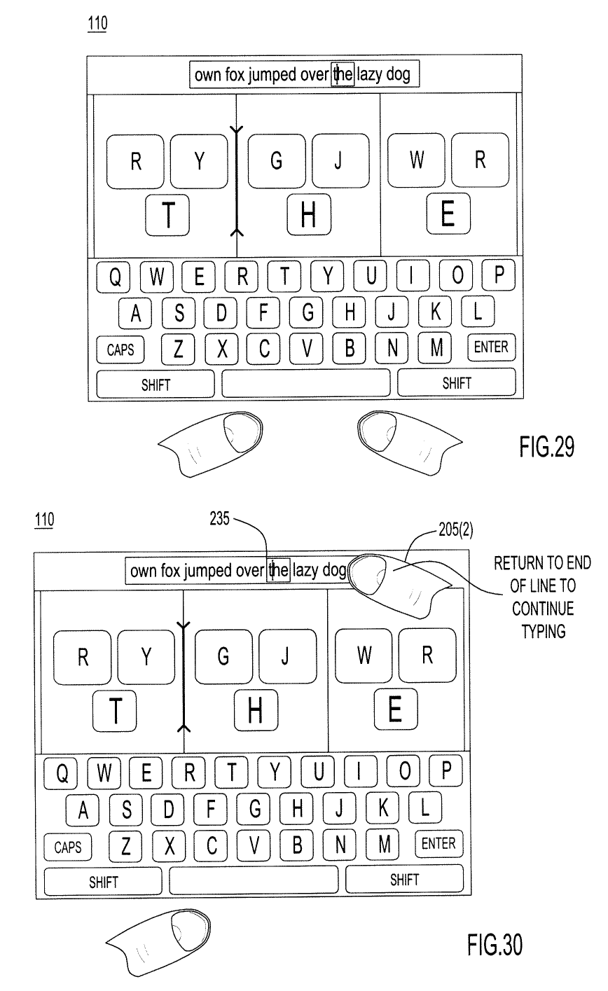

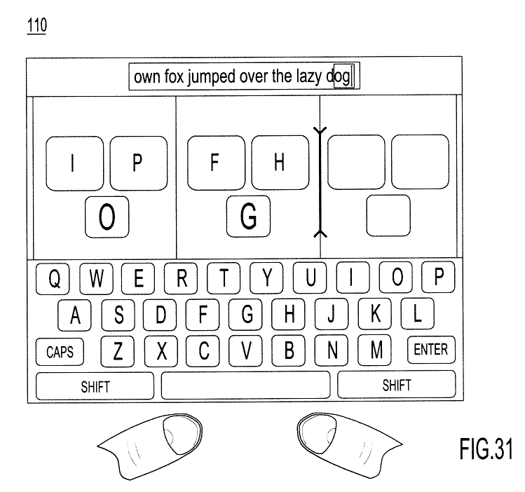

A different scenario is now described with reference to FIGS. 23-29. A user has been typing for a while and realizes that the word “fox” in a phrase is misspelled as “foz”. In FIG. 24, the user simply taps the text box 235 in the area of the spelling error to set an approximate position of the text box cursor 225 using digit 205(1). The TEXTTOUCH process 445 is called and the result is shown in FIG. 25. In this example, the text in the text box 235 has been re-centered around the cursor position, the overlay 230 has also been re-centered and encompasses the typographical error, the key groups 240(1)-240(3) reflect the text within the overlay 230, and the text box cursor 225 and enlarged cursor 210 have been properly repositioned. It should be understood that the above items need not be re-centered as long as there is available space in the text box 235. In FIG. 26, the user touches the “x” error correction key 220(6) in the third key group 240(3) using digit 205(2). FIG. 27 shows that “foz” has been corrected to “fox” and the third key group 240(3) has been updated accordingly. In FIG. 28, the user taps the end of the text box 235 using digit 205(2). Again the TEXTTOUCH process 445 is called and the text has been re-centered over “t|he”. The result is shown in FIG. 29. In FIG. 30, the user again taps the end of the text box 235 using digit 205(2). The TEXTTOUCH process 445 is called and the result is shown in FIG. 31. The user may then continue typing from the end of the text just as before the “foz” spelling error was realized.

FIGS. 32-37 illustrate alternative examples of key groups. FIG. 32 shows an embodiment with a set of error correction keys 3220(1) and 3220(2) placed above and diagonal to the tapped key 3215. The selected or tapped key and the set of adjacent error correction keys may be enlarged relative to a size of the keys displayed in the touchscreen keyboard. FIG. 33 shows set of error correction keys 3320(1) and 3320(2) placed above and diagonal to the tapped key 3315. The keys in FIG. 33 are smaller than those in FIG. 32 and are designed for smaller error correction key areas or error correction key areas displaying more key groups within a given error correction key area. FIG. 34 shows set of error correction keys 3420(1) and 3420(2) placed above and diagonal to the tapped key 3415 along with an enlarged delete key 3430. When the enlarged delete key 3430 or other delete key on the touchscreen keyboard is tapped, then the DELETEKEY process 440 is executed as described above and characters are deleted from the text box and error correction key area, respectively. As described above, in other embodiments the “delete” button may be represented by an icon or may be positioned differently within the group, to minimize the chances of it being accidentally tapped. FIG. 35 shows set of error correction keys 3520(1) and 3520(2) partially surrounding the tapped key 3515. The keys in FIG. 35 are designed for an error correction key area with a larger amount of horizontal and vertical space allocated to each error correction key. FIG. 36 shows set of error correction keys 3620(1) and 3620(2) placed on either side of the tapped key 3615. The keys in FIG. 36 are designed for an error correction key area with a larger amount of horizontal space than vertical space. Finally, FIG. 37 shows a set of error correction keys 3720(1)-3720(6) surrounding the tapped key 3715. The keys in FIG. 37 are designed for an error correction key area with a large amount of horizontal and vertical space in which all keys adjacent to the tapped key on the touchscreen keyboard are displayed as error correction keys along with the tapped key.

Techniques are provided for correcting input errors on a device with a touchscreen display and touchscreen keyboard. An area of the touchscreen display is reserved for input error correction and correction keys are displayed in the input error correction area of the touchscreen display. A user can select or tap the one of the correction keys to easily correct typographical errors.

Although the apparatus, method, and logic are illustrated and described herein as embodied in one or more specific examples, it is nevertheless not intended to be limited to the details shown, since various modifications and structural changes may be made therein without departing from the scope of the apparatus, logic, and method and within the scope and range of equivalents of the claims. Accordingly, it is appropriate that the appended claims be construed broadly and in a manner consistent with the scope of the apparatus, logic, and method, as set forth in the following claims.

What is claimed is:

1. A method comprising:
receiving an input from a touchscreen keyboard of a touchscreen display device having a display area, wherein the touchscreen keyboard is displayed in a first part of a display area and the input represents a selected key on the touchscreen keyboard;
displaying a character corresponding to the selected key in a text box that is displayed in a second part of the display area;
determining a set of adjacent keys that are adjacent to the selected key on the touchscreen keyboard;
displaying the selected key and the set of adjacent keys in a third part of the display area;
receiving from the third part of the display area a correction touchscreen input for a key selected from among the set of adjacent keys; and
replacing a character displayed in the text box with a character corresponding to the correction touchscreen input.

2. The method of claim 1, wherein displaying the selected key and the set of adjacent keys comprises displaying the selected key and/or the set of adjacent keys enlarged relative to a size of the keys displayed in the touchscreen keyboard.

3. The method of claim 1, wherein displaying the selected key and the set of adjacent keys comprises displaying a set of N selected keys and a corresponding set of adjacent keys within the third part of the display area as consecutive inputs are received from the touchscreen keyboard.

4. The method of claim 3, further comprising:
displaying with a distinguishing indicator a set of contiguous characters in the text box to form a window of distinguished characters; and
displaying the set of N selected keys corresponding to the characters displayed in the window.

5. The method of claim 4, further comprising:
displaying a cursor among characters in the window representing a character insertion or character deletion point;
maintaining a position of the window relative to the cursor as characters are added or deleted; and
updating the set of N selected keys corresponding to the characters displayed in the window.

6. The method of claim 4, further comprising:
receiving a touchscreen input in the text box to set an approximate position of a cursor;
maintaining a position of the window relative to the cursor;
displaying the set of N selected keys corresponding to the characters within the window; and
displaying an enlarged cursor in a relative position among the set of N selected keys corresponding to the position of the cursor displayed among the characters in the window.

7. The method of claim 4, further comprising:
receiving an input from the third part of the display area representing an area between selected keys, an area to the right of the rightmost selected key, or an area to the left of the leftmost selected key;
moving the enlarged cursor to an area within the third part of the display area corresponding to the input received from the third part of the display area; and
moving the cursor and the window to an area within the text box corresponding to the position of the enlarged cursor.

8. The method of claim 7, wherein when the input received from the third part of the display represents the area to the left of the leftmost selected key, and further comprising:
scrolling the group of selected keys to the right if the leftmost key is not the first character in the text box;
moving the enlarged cursor to an area within the third part of the display area corresponding to the area one selected key to the right of leftmost area;
scrolling the characters in the text box to the right if the character represented by the new left most selected key is not currently visible; and
wherein when the input received from the third part of the display represents the area to the right of the rightmost selected key, and further comprising:
scrolling the group of selected keys to the left if the leftmost key is not the last character in the text box;
moving the enlarged cursor to an area within the third part of the display area corresponding to the area one selected key to the left of rightmost area; and
scrolling the characters in the text box to the left if the character represented by the new right most selected key is not currently visible.

9. The method of claim 1, wherein displaying the selected key and the set of adjacent keys further comprises displaying a delete key, and further comprising:
receiving an input from the third part of the display selecting the delete key;
removing the character corresponding to the selected key from the text box; and
removing the selected key and the set of adjacent keys from the third part of the display area.

10. An apparatus comprising:
a touchscreen configured to display information; and
a processor configured to:
display on the touchscreen a touchscreen keyboard, a text box display area, and an error correction display area;
receive an input from the touchscreen keyboard, wherein the input represents a selected key on the touchscreen keyboard;
display a character corresponding to the selected key in the text box;
determine a set of adjacent keys that are adjacent to the selected key on the touchscreen keyboard;
display the selected key and the set of adjacent keys in the error correction display area;
receive from the error correction display area a correction touchscreen input for a key selected from among the set of adjacent keys; and
replace a character displayed in the text box with a character corresponding to the correction touchscreen input.

11. The apparatus of claim 10, wherein the processor is configured to display on the touchscreen the selected key and/or the set of adjacent keys enlarged relative to a size of the keys displayed in the touchscreen keyboard.

12. The apparatus of claim 10, wherein the processor is configured to display on the touchscreen the selected key and the set of adjacent keys displays a set of N selected keys and a corresponding set of adjacent keys within the error correction display area as consecutive inputs are received from the touchscreen keyboard.

13. The apparatus of claim 12, wherein the processor is further configured to:
display with a distinguishing indicator a set of contiguous characters in the text box on the touchscreen to form a window of distinguished characters; and
display the set of N selected keys corresponding to the characters displayed in the window.

14. The apparatus of claim 13, wherein the processor is further configured to:
display a cursor among characters in the window representing a character insertion or character deletion point;
maintain a position of the window relative to the cursor as characters are added or deleted; and
update the set of N selected keys corresponding to the characters displayed in the window.

15. The apparatus of claim 13, wherein the processor is further configured to:
receive a touchscreen input in the text box to set an approximate position of a cursor;
maintain a position of the window relative to the cursor;
display the set of N selected keys corresponding to the characters within the window; and
display an enlarged cursor in a relative position among the set of N selected keys corresponding to the position of the cursor displayed among the characters in the window.

16. The apparatus of claim 13, wherein the processor is further configured to:
receive an input from the third part of the display area representing an area between selected keys, an area to the right of the rightmost selected key, or an area to the left of the leftmost selected key;
move the enlarged cursor to an area within the third part of the display area corresponding to the input received from the third part of the display area; and
move the cursor and the window to an area within the text box corresponding to the position of the enlarged cursor.

17. The apparatus of claim 16, wherein the processor is configured to receive an input from the third part of the display representing the area to the left of the leftmost selected key, and wherein the processor is further configured to:
scroll the group of selected keys to the right if the leftmost key is not the first character in the text box;
move the enlarged cursor to an area within the third part of the display area corresponding to the area one selected key to the right of leftmost area;
scroll the characters in the text box to the right if the character represented by the new left most selected key is not currently visible; and
wherein the processor is configured to receive an input from the third part of the display representing the area to the right of the rightmost selected key, and wherein the processor is further configured:
scroll the group of selected keys to the left if the leftmost key is not the last character in the text box;
move the enlarged cursor to an area within the third part of the display area corresponding to the area one selected key to the left of rightmost area;
scroll the characters in the text box to the left if the character represented by the new right most selected key is not currently visible.

18. The apparatus of claim 10, wherein the processor is configured to display on the touchscreen the selected key and the set of adjacent keys is further configured to display a delete key, and wherein the processor is further configured:
receive an input from the third part of the display selecting the delete key;
remove the character corresponding to the selected key from the text box; and
remove the selected key and the set of adjacent keys from the third part of the display area.

19. Logic encoded in one or more tangible media for execution and when executed operable to:
receive an input from a touchscreen keyboard of a touchscreen display device having a display area, wherein the touchscreen keyboard is displayed in a first part of a display area and the input represents a selected key on the touchscreen keyboard;
display a character corresponding to the selected key in a text box that is displayed in a second part of the display area;
determine a set of adjacent keys that are adjacent to the selected key on the touchscreen keyboard;
display the selected key and the set of adjacent keys in a third part of the display area;
receive from the third part of the display area a correction touchscreen input for a key selected from among the set of adjacent keys; and
replace a character displayed in the text box with a character corresponding to the correction touchscreen input.

20. The logic of claim 19, wherein the logic that displays a character corresponding to the selected key comprises logic configured to display the selected key and/or the set of adjacent keys enlarged relative to a size of the keys displayed in the touchscreen keyboard.

21. The logic of claim 19, wherein the logic that displays the selected key and the set of adjacent keys comprises logic configured to display a set of N selected keys and a corresponding set of adjacent keys within the third part of the display area as consecutive inputs are received from the touchscreen keyboard.

22. The logic of claim 21, further comprising logic configured to:
display with a distinguishing indicator a set of contiguous characters in the text box to form a window of distinguished characters; and
display the set of N selected keys corresponding to the characters displayed in the window.
